(19) United States
(12) Patent Application Publication
(10) Pub. No.: US 2018/0144338 A1
(43) Pub. Date: May 24, 2018

(54) METHOD AND SYSTEM FOR CONTROLLED ACCESS AND USAGE OF PAYMENT CREDENTIALS

(71) Applicant: Mastercard International Incorporated, Purchase, NY (US)

(72) Inventors: Keun Dong KIM, Tenafly, NJ (US); Malik DHANANI, New York, NY (US)

(73) Assignee: Mastercard International Incorporated, Purchase, NY (US)

(21) Appl. No.: 15/355,799

(22) Filed: Nov. 18, 2016

(51) Int. Cl. G06Q 20/38; H04L 29/06; G06F 17/30; G06Q 20/20; G06Q 20/32

(52) U.S. Cl. CPC G06Q 20/3821; H04L 63/0428; G06F 17/30864; H04L 2209/80; G06Q 20/3226; H04L 2209/56; G06Q 20/202

(57) ABSTRACT

A method for distributing limited use payment credentials includes: receiving, by a receiving device of a computing device, payment credentials associated with a transaction account, wherein the payment credentials are subject to one or more transaction controls governing usage in a payment transaction; storing, in a memory of the computing device, the received payment credentials; preventing, by a security module of the computing device, audio or visual access to the stored payment credentials by a user of the computing device; and electronically transmitting, by the computing device, the payment credentials to a point of sale system.

### FIELD

The present disclosure relates to the controlled access and usage of payment credentials, specifically the provisioning of limited use payment credentials to a computing device where access thereto by a user of the computing device is restricted.

### BACKGROUND

As transaction accounts and the technology associated therewith have improved, individuals have begun to use transaction accounts more and more to fund payment transactions as opposed to physical currency. Transaction accounts often provide account holders with several benefits in their usage, such as electronic statements, transaction controls, and the ability to access and use their transaction account via a computing device.

At the same time, many account holders are also interested in being able to authorize another individual to conduct a transaction on their behalf or otherwise using their money. For instance, an employer may provide an employee with a corporate credit card to purchase items for the business. In such instances, the use of transaction controls has provided the account holders or other account administrators with the ability to control the transactions conducted using the transaction account. Thus, a parent or employer may limit how much their child or employee may spend, control the merchants at which their child or employee transact, etc.

However, existing financial institutions and transaction processing systems are configured to apply transaction controls during the processing of a payment transaction without regard to the payment credentials for the transaction account itself. Thus, it is often up to the parent, employer, or other administrator to have the payment credentials provisioned to the individual that is to use them. Furthermore, existing systems lack the ability to control access to the payment credentials once provisioned. Thus, a child or employee may freely obtain the account number that is provisioned or may freely redistribute the payment credentials to other users or devices, even against the wishes of the administrator. In such cases, transaction controls may be insufficient to fulfill the wishes of the account holder or administrator. As a result, existing financial institution and transaction processing systems are unable to provide controls on both the use of payment credentials for a payment transaction as well as the access to the payment credentials themselves as a secondary means of protection.

Thus, there is a need for a technological solution where an account holder or administrator may set transaction controls on a transaction account where payment credentials associated therewith are provisioned for usage by another individual, where access to the payment credentials is prevented such that the individual may not be able to do more than use the credentials in a transaction account that is subject to the transaction controls.

### SUMMARY

The present disclosure provides a description of systems and methods for distributing limited use payment credentials. The payment credentials are subject to transaction controls and thus may not be used in payment transactions that are not in compliance with the transaction controls, which are set by an authorized administrator. In addition, the computing device to which the payment credentials are provisioned is configured to prevent audio or visual access to the payment credentials, such that the payment credentials may not be redistributed or used by the recipient via another computing device or method to provide for additional control and account security to account holders and administrators. As a result, the payment credentials may be protected from unauthorized access and redistribution, in addition to protection from misuse in unauthorized payment transactions, providing a secondary level of protection that is not available in existing financial institution and transaction processing systems.

A method for distributing limited use payment credentials includes: receiving, by a receiving device of a computing device, payment credentials associated with a transaction account, wherein the payment credentials are subject to one or more transaction controls governing usage in a payment transaction; storing, in a memory of the computing device, the received payment credentials; preventing, by a security module of the computing device, audio or visual access to the stored payment credentials by a user of the computing device; and electronically transmitting, by the computing device, the payment credentials to a point of sale system.

A system for distributing limited use payment credentials includes: a receiving device of a computing device configured to receive payment credentials associated with a transaction account, wherein the payment credentials are subject to one or more transaction controls governing usage in a payment transaction; a memory of the computing device configured to store the received payment credentials; a security module of the computing device configured to prevent audio or visual access to the stored payment credentials by a user of the computing device, wherein the computing device is configured to electronically transmit the payment credentials to a point of sale system.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the distribution of limited use payment credentials in accordance with exemplary embodiments.

FIG. 2 is a block diagram illustrating the computing device of the system of FIG. 1 for the receipt of and controlled access to payment credentials in accordance with exemplary embodiments.

FIG. 3 is a flow diagram illustrating a process for the distribution of payment credentials to the computing device of FIG. 2 using the system of FIG. 1 in accordance with exemplary embodiments.

FIG. 4 is a flow diagram illustrating a process for the use of access-controlled payment credentials in a payment transaction using the system of FIG. 1 in accordance with exemplary embodiments.

FIG. 5 is a flow chart illustrating an exemplary method for distributing limited use payment credentials in accordance with exemplary embodiments.

FIG. 6 is a flow diagram illustrating the processing of a payment transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Controlled Payment Number—Controlled payment numbers may be payment numbers associated with a payment account that are subject to one or more rules. In many cases, these rules may be set by a cardholder, such as spending limits, limits on days and/or times of a transaction, limits on merchants or industries, transaction spending or frequency limits, etc. Controlled payment numbers may offer an account holder an opportunity to give payment cards tied to the account to others for use, but subject to rules set by the cardholder, such as an employer distributing cards to employees, or a parent distributing cards to children. Additional detail regarding controlled payment numbers may be found in U.S. Pat. No. 6,636,833, issued Oct. 21, 2003; U.S. Pat. No. 7,136,835, issued Nov. 14, 2006; U.S. Pat. No. 7,571,142, issued Aug. 4, 2009; U.S. Pat. No. 7,567,934, issued Jul. 28, 2009; U.S. Pat. No. 7,593,896, issued Sep. 22, 2009; U.S. patent application Ser. No. 12/219,952, filed Jul. 30, 2008; U.S. patent application Ser. No. 12/268,063, filed Nov. 10, 2008; and U.S. patent application Ser. No. 12/359,971, filed Jan. 26, 2009; each of which are herein incorporated by reference in their entirety.

### System for Controlled Access and Usage of Payment Credentials

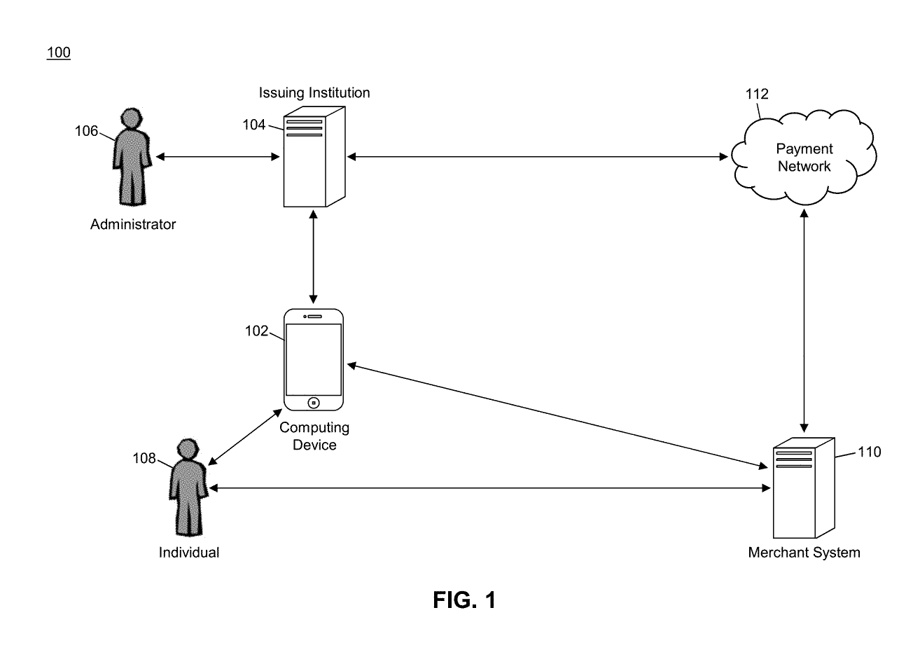

FIG. 1 illustrates a system 100 for the controlled access and usage of limited use payment credentials via a computing device.

The system 100 may include a computing device 102. The computing device 102, discussed in more detail below, may be configured to store limited use payment credentials therein that are associated with a transaction account, for which access thereto is limited. The computing device 102, as discussed below, may be any type of computing device suitable for performing the functions discussed herein, such as a desktop computer, laptop computer, notebook computer, tablet computer, cellular phone, smart phone, smart watch, smart television, wearable computing device, implantable computing device, etc. The computing device 102 may be specifically configured to perform the functions discussed herein, and may include one or more application programs that may be configured to perform the functions discussed herein, which may include an electronic wallet application program configured to perform traditional functions associated thereto that will be apparent to persons having skill in the relevant art. In some instances, the computing device 102 may be configured to operate using one or more cloud computing techniques such that the payment credentials provisioned thereto may be provisioned to one or more external computing systems comprising the cloud, where the payment credentials are made available to the computing device 102 though a reference to a memory location in cloud storage, and thus being stored in the computing device 102 by virtue of the computing device's access to the cloud storage.

In the system 100, limited use payment credentials may be provisioned to the computing device 102 that are associated with a transaction account that is issued by an issuing institution 104. The issuing institution 104 may be a financial institution or other entity configured to issue transaction accounts that are used in the funding of payment transactions. The issuing institution 104 may issue the transaction account to which the payment credentials provisioned to the computing device 102 are associated. In some embodiments, the issuing institution 104 may be configured to provision the payment credentials to the computing device 102. In other embodiments, one or more alternative computing systems and/or entities may be configured to provision the payment credentials to the computing device 102, such as on behalf of the issuing institution 104.

The payment credentials provisioned to the computing device 102 may be subject to one or more transaction controls. The transaction controls may be set by an administrator 106 of the transaction account, which may be the account holder or another authorized user. The transaction controls may be set by any suitable method, such as via interaction between the administrator 106 and an employee of the issuing institution 104, via a computing device (e.g., using a web page, application program, etc.). Transaction controls may be placed on the transaction account such that payment transactions conducted using the transaction account must be in compliance with the transaction controls. Transaction controls may be on a per-transaction basis or may be applicable to a plurality of payment transactions, such as conducted during a predefined period of time (e.g., daily, weekly, monthly, yearly, etc.).

In some cases, transaction controls may be applicable to a specific individual, payment card, or other demarcation of the transaction account. In some instances, the issuing institution 104 may generate a new transaction account number for the transaction account, where the new transaction account number is subject to the transaction controls. Such a transaction account number may be referred to herein as a controlled payment number. In some cases, a transaction account as a whole may be subject to transaction controls, while one or more controlled payment numbers associated thereto may have additional transaction controls associated therewith. Transaction controls may include controls on transaction amount, aggregate spending amount, merchant name, merchant category code, merchant industry, product categories, transaction time, transaction date, geographic location, payment method, currency, etc.

The administrator 106 may thus set transaction controls for the payment credentials that are provisioned to the computing device 102, which may be associated with an individual 108 by whom usage of the payment credentials is intended. In some embodiments, the administrator 106 may indicate the individual 108 or the computing device 102 to which the payment credentials are to be provisioned, which may be used by the issuing institution 104 (e.g., and/or other associated systems or entities) in the provisioning of payment credentials. For example, the administrator 106 may provide the issuing institution 104 with a device identifier (e.g., media access control address, internet protocol address, serial number, registration number, email address, telephone number, username, etc.) or other identifying information for the computing device 102, such that the payment credentials are provisioned to the correct computing device 102. For example, the administrator 106 may be a parent that ensures the payment credentials are provisioned to their child's (e.g., as the individual 108) smart phone, or the administrator 106 as an employer may ensure the payment credentials are provisioned to an employee's (e.g., as the individual 108) assigned computer at the office. In such cases, the issuing institution 104 may provision payment credentials to the corresponding computing device 102.

The computing device 102 may be configured to receive the payment credentials and store the credentials therein. In some embodiments, the payment credentials may be stored in a secure storage, such as a Secure Element or other suitable type of secured storage that will be apparent to persons having skill in the relevant art. The computing device 102 (e.g., via an application program installed therein and executed thereby) may be further configured to prevent access to the payment credentials by the individual 108 aside from the usage thereof. For instance, the computing device 102 may prevent audio or visual access to the payment credentials or associated data and may prevent the redistribution of the payment credentials to another computing device 102. Thus, the individual 108 may not be able to read the controlled payment number or other data that may enable the individual 108 to use the transaction account in a payment transaction without being conducted using the computing device 102 to which the payment credentials have been provisioned.

The computing device 102 may be configured to enable the individual 108 to use the payment credentials in a payment transaction at a merchant. In such instances, the individual 108 may instruct (e.g., via a suitable input device of the computing device 102) the computing device 102 to electronically transmit payment credentials to a merchant system 110 associated with the merchant, such as a point of sale device. The payment credentials may be electronically transmitted using any suitable method. For instance, in a first example, the computing device 102 may electronically transmit a data signal superimposed with the payment credentials to the merchant system 110 via near field communication. In a second example, the computing device 102 may display a machine-readable code (e.g., a quick response code, a bar code, etc.) that is encoded with the payment credentials, which may be read by the merchant system 110. In a third example, the computing device 102 may submit the payment credentials via a web page hosted by or on behalf of the merchant system 110 for transmission thereto.

The merchant system 110 may receive the payment credentials and may submit the payment credentials, along with additional transaction data associated with the payment transaction, to a payment network 112 for processing. In some embodiments, the merchant system 110 may submit the transaction data directly to the payment network 112. In other embodiments, the transaction data may be transmitted via one or more intermediate entities, such as an acquiring institution or gateway processor.

In some cases, the transaction data may be formatted in a transaction message prior to submission to the payment network. The transaction message may be generated by the merchant system 110, or by an intermediate entity using the transaction data provided by the merchant system 110. Transaction messages may be specially formatted data messages that are formatted pursuant to one or more standards governing the exchange of financial transaction messages, such as the International Organization of Standardization's ISO 8583 or 20022 standards. Transaction messages may include message type indicators indicative of the type of the transaction message (e.g., authorization request, authorization response, etc.) and a plurality of data elements, where each data element is configured to store transaction data as set forth in the associated standard(s). In some instances, a transaction message may also include one or more bitmaps, which may be configured to indicate the data elements included in the transaction message and the data stored therein.

The payment network 112 may receive the transaction message for the payment transaction and may process the payment transaction accordingly using traditional methods and systems. As part of the processing of the payment transaction, the payment transaction may be evaluated for compliance with the transaction controls set for the payment credentials used in the payment transaction (e.g., provisioned to the computing device 102). In some instances, the evaluation may be performed by the payment network 112 prior to the forwarding of an authorization request to the issuing institution 104. In other instances, the issuing institution 104 may perform the evaluation as part of authorization of the payment transaction. In yet another instance, the evaluation may be performed by a third party, such as an additional entity configured to process transaction controls on behalf of the issuing institution 104. In such embodiments, the third party entity may be configured to generate controlled payment numbers, and may also be configured to provision controlled payment numbers to computing devices 102 on behalf of the issuing institution 104.

If the payment transaction is not in compliance with the transaction controls (e.g., the transaction amount exceeds a spending limit, the geographic location is outside of an authorized area, etc.), then, in some instances, the payment transaction may be denied and an authorization response that includes a data element that stores a response code indicating the transaction is denied may be provided to the merchant system 110 via the payment network 112. In other instances, the authorization request may be forwarded to the issuing institution 104 with an indication that one or more transaction controls were denied, for final approval or denial by the issuing institution 104. If the transaction controls are complied with, the authorization request may be forwarded to the issuing institution 104 for approval or denial using traditional methods.

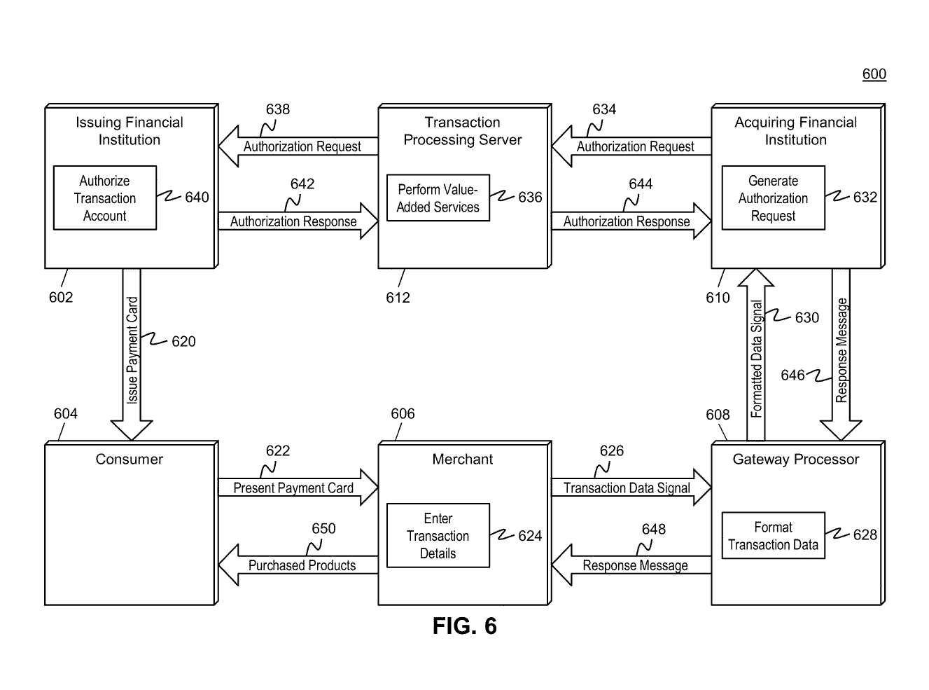

The issuing institution 104 may return an authorization response to the payment network 112, which may forward the authorization response or data included therein to the merchant system 110 (e.g., via one or more intermediate entities, as applicable). The merchant system 110 may then finalize the payment transaction, such as by furnishing the transacted—for goods or services to the individual 108, providing a receipt, etc. The individual 108 may thus conduct a payment transaction on behalf of, or with the permission of, the administrator 106 that is performed subject to the controls set by the administrator 106, and without the individual 108 having had access to the payment credentials themselves beyond their usage in the payment transaction. Additional information regarding the use of transaction messages and processing of payment transactions is discussed in more detail below with respect to the process 600 illustrated in FIG. 6.

In some embodiments, the computing device 102 may be further configured to integrate with other computing systems or application programs associated with the administrator 106 and/or individual 108. For example, the administrator 106 may be a business or person that uses an expense management system, inventory management system, budgeting program, or other type of system or application that uses transaction data as part of the management or execution thereof. In such instances, the computing device 102 may be configured to receive transaction data from the payment transaction, such as in a receipt, which may be conveyed to the computing device 102 from the merchant system 110, issuing institution 104, payment network 112, or a third party entity. For example, the merchant system 110 may return transaction data to the application program used to convey the payment credentials. In another example, the issuing institution 104 may send an email reporting the payment transaction to the computing device 102, which may parse the transaction data from the email. In any instance, the computing device 102 may be configured to electronically transmit the transaction data to the expense management system, inventory management system, or other system or application program for use thereof. In such cases, an administrator 106 may have their management systems timely and accurately updated regarding payment transactions conducted by authorized individuals, without the need for reporting by individuals 108 and without the administrator 106 or another authorized person having to contact the issuing institution 104 to access the data, which may expedite accounting, management, and other functions. Thus, the administrator 106 may be provided with both increased security due to the controlled access and usage of the payment credentials as well as increased convenience in the use of those payment credentials in payment transactions that must be tracked or reported.

Thus, the present disclosure discusses methods and systems for the distribution and use of limited use payment credentials that are secured from access by an individual 108 of a computing device 102, but for which usage may be controlled. Because the access is controlled on the computing device 102 itself based on its specialized configuration as discussed herein, such increased security may be provided to administrators 106 without the need for modification to existing systems or to modification of issuing institution 104 systems. As a result, the methods and systems discussed herein may provide for significant benefits to administrators 106 and issuing institutions 104 with a minimum amount of participation.

### Computing Device

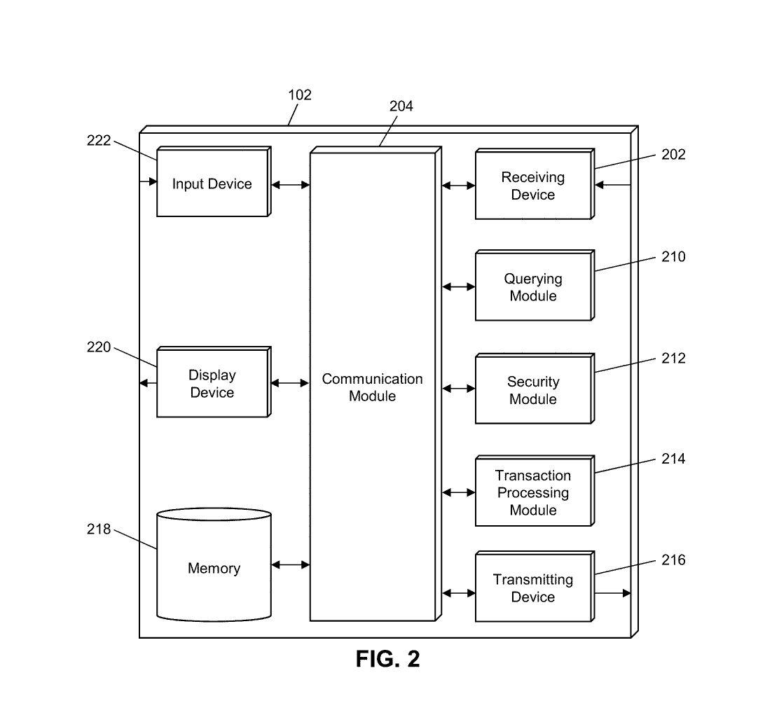

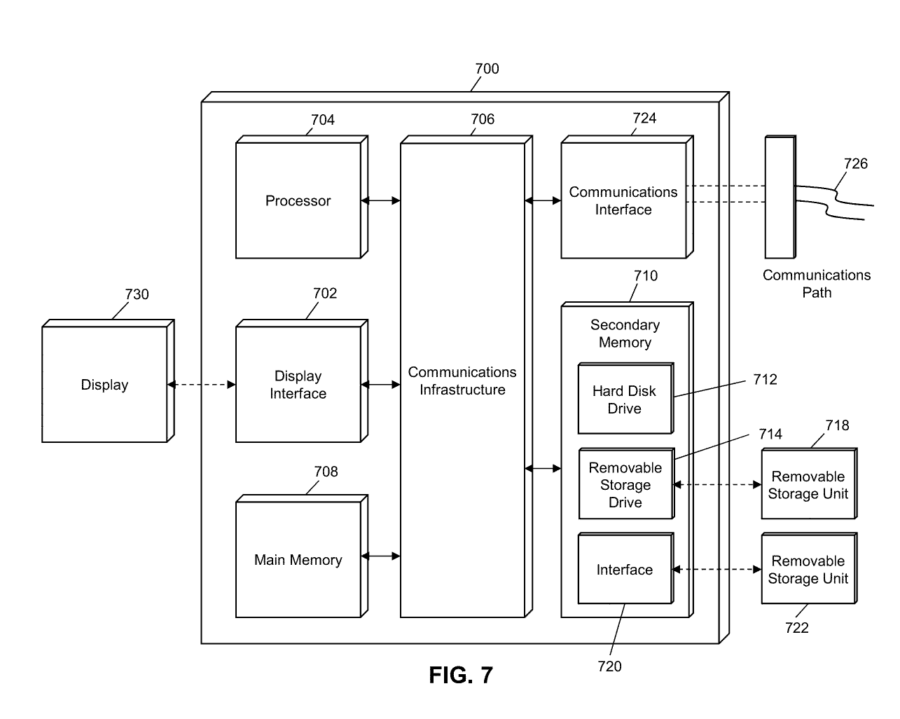

FIG. 2 illustrates an embodiment of a computing device 102 in the system 100. It will be apparent to persons having skill in the relevant art that the embodiment of the computing device 102 illustrated in FIG. 2 is provided as illustration only and may not be exhaustive to all possible configurations of the computing device 102 suitable for performing the functions as discussed herein. For example, the computer system 700 illustrated in FIG. 7 and discussed in more detail below may be a suitable configuration of the computing device 102.

The computing device 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 112 for the transmission of transaction messages that include sensitive financial data and information. In some instances, the receiving device 202 may also be configured to receive data from issuing institutions 104, merchant systems 110, payment networks 112, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by issuing institutions 104 or other associated entities or systems that may be superimposed or otherwise encoded with payment credentials. Payment credentials may include an account number (e.g., a controlled payment number) and any other data used in the funding of a payment transaction, such as a name, expiration date, security code, payment cryptogram, etc. The receiving device 202 may also be configured to receive data signals electronically transmitted by merchant systems 110, such as may be superimposed or otherwise encoded with data used in the conveyance of payment credentials, such as transaction data or merchant data used by the computing device 102 in the calculation of payment cryptograms or authorization for the transmission of payment credentials. In some embodiments, the receiving device 202 may also be configured to receive data signals superimposed or otherwise encoded with transaction data for a processing payment transaction, such as may be electronically transmitted by an issuing institution 104, merchant system 110, payment network 112, or third party entity, which may be included in an e-mail, short message service message, or other suitable type of transmission.

The computing device 102 may also include a communication module 204. The communication module 204 may be configured to transmit data between modules, engines, databases, memories, and other components of the computing device 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the computing device 102 and external components of the computing device 102, such as externally connected databases, display devices, input devices, etc. The computing device 102 may also include a processing device. The processing device may be configured to perform the functions of the computing device 102 discussed herein as will be apparent to persons having skill in the relevant art. In some embodiments, the processing device may include and/or be comprised of a plurality of engines and/or modules specially configured to perform one or more functions of the processing device, such as a querying module 210, security module 212, transaction processing module 214, etc. As used herein, the term “module” may be software or hardware particularly programmed to receive an input, perform one or more processes using the input, and provides an output. The input, output, and processes performed by various modules will be apparent to one skilled in the art based upon the present disclosure.

The computing device 102 may include a querying module 210. The querying module 210 may be configured to execute queries on databases to identify information. The querying module 210 may receive one or more data values or query strings, and may execute a query string based thereon on an indicated database, such as a memory 218, to identify information stored therein. The querying module 210 may then output the identified information to an appropriate engine or module of the computing device 102 as necessary. The querying module 210 may, for example, execute a query on the memory 218 to identify payment credentials stored therein for transmission to a merchant system 110 as part of a payment transaction. The querying module 210 may also be configured to execute queries on the memory 218 to replace payment credentials, such as in instances where new payment credentials are received, such as in an account number has been changed due to a lost or stolen card.

The computing device 102 may also include a security module 212. The security module 212 may be configured to secure data that is stored in the memory 218 of the computing device 102 from access by a user (e.g., the individual 108). The security module 212 may, for example, control access to the payment credentials stored in the memory 218 from the individual 108, to prevent the individual 108 from viewing or hearing data related to the payment credentials, or from redistributing the payment credentials to another computing device 108. The security module 212 may enable the individual 108 to initiate the transmission of payment credentials to a merchant system 110 for usage in a payment transaction, but may be configured to prevent all other access or usage of the payment credentials.

The computing device 102 may also include a transaction processing module 214. The transaction processing module 214 may be configured to perform functions related to the initiation and processing of payment transactions. For example, the transaction processing module 214 may be configured to generate payment cryptograms, calculate transaction amounts or data related thereto, perform currency conversions, encode machine-readable codes with payment credentials, generate data signals for electronic transmission that are superimposed or otherwise encoded with payment credentials, etc. Additional functions that may be performed by the transaction processing module 214 will be apparent to persons having skill in the relevant art.

The computing device 102 may also include a transmitting device 216. The transmitting device 216 may be configured to transmit data over one or more networks via one or more network protocols. In some embodiments, the transmitting device 216 may be configured to transmit data over the payment rails, such as using specially configured infrastructure associated with payment networks 112 for the transmission of transaction messages that include sensitive financial data and information, such as identified payment credentials. In some instances, the transmitting device 216 may be configured to transmit data to issuing institutions 104, merchant systems 110, payment networks 112, and other entities via alternative networks, such as the Internet. In some embodiments, the transmitting device 216 may be comprised of multiple devices, such as different transmitting devices for transmitting data over different networks, such as a first transmitting device for transmitting data over the payment rails and a second transmitting device for transmitting data over the Internet. The transmitting device 216 may electronically transmit data signals that have data superimposed that may be parsed by a receiving computing device. In some instances, the transmitting device 216 may include one or more modules for superimposing, encoding, or otherwise formatting data into data signals suitable for transmission.

The transmitting device 216 may be configured to electronically transmit data signals to issuing institutions 104 that are superimposed or otherwise encoded with requests for payment credentials or transaction data. The transmitting device 216 may also be configured to electronically transmit data signals to merchant systems 110 that are superimposed or otherwise encoded with payment credentials, such as via near field communication, a local area network, a web page, etc. The transmitting device 216 may also be configured to electronically transmit data signals to other modules or application programs in the computing device 108, or to external computing devices, such as may be superimposed or otherwise encoded with transaction data for processed payment transactions, such as may be transmitted for use by an expense management system or application, budgeting system or application, etc.

The computing device 102 may also include a memory 218. The memory 218 may be configured to store data for use by the computing device 102 in performing the functions discussed herein, such as payment credentials provisioned thereto. The memory 218 may be configured to store data using suitable data formatting methods and schema and may be any suitable type of memory, such as read-only memory, random access memory, etc. The memory 218 may include, for example, encryption keys and algorithms, communication protocols and standards, data formatting standards and protocols, program code for modules and application programs of the processing device, and other data that may be suitable for use by the computing device 102 in the performance of the functions disclosed herein as will be apparent to persons having skill in the relevant art. In some embodiments, the memory 218 may be comprised of or may otherwise include a relational database that utilizes structured query language for the storage, identification, modifying, updating, accessing, etc. of structured data sets stored therein.

The computing device 102 may also include or be otherwise be interfaced with one or more input devices 222. The input devices 222 may be internal to the computing device 102 or external to the computing device 102 and connected thereto via one or more connections (e.g., wired or wireless) for the transmission of data to and/or from. The input devices 222 may be configured to receive input from a user of the computing device 102, such as the individual 108, which may be provided to another module or engine of computing device 102 (e.g., via the communication module 204) for processing accordingly. Input devices 222 may include any type of input device suitable for receiving input for the performing of the functions discussed herein, such as a keyboard, mouse, click wheel, scroll wheel, microphone, touch screen, track pad, camera, optical imager, etc. The input device 222 may be configured to, for example, receive input from the individual 108 requesting usage of payment credentials stored therein, such as transmission of the payment credentials to a merchant system 110 for use in funding a payment transaction.

The computing device 102 may also include or be otherwise interfaced with a display device 220. The display device 220 may be internal to the computing device 102 or external to the computing device 102 and connected thereto via one or more connections (e.g., wired or wireless) for the transmission of data to and/or from. The display device 220 may be configured to display data to a user of the computing device 102, such as the individual 108. The display device 220 may be any type of display suitable for displaying data as part of the functions discussed herein, such as a liquid crystal display, light emitting diode display, thin film transistor display, capacitive touch display, cathode ray tube display, light projection display, etc. In some instances, the computing device 102 may include multiple display devices 220. The display device 220 may be configured to, for example, display a machine-readable code (e.g., quick response code, bar code, etc.) encoded with payment credentials for transmission to a merchant system 110. The display device 220 may also be configured to display instructions to the individual 108 for requesting usage of the payment credentials for a payment transaction.

### Process for Distribution of Limited Use Payment Credentials

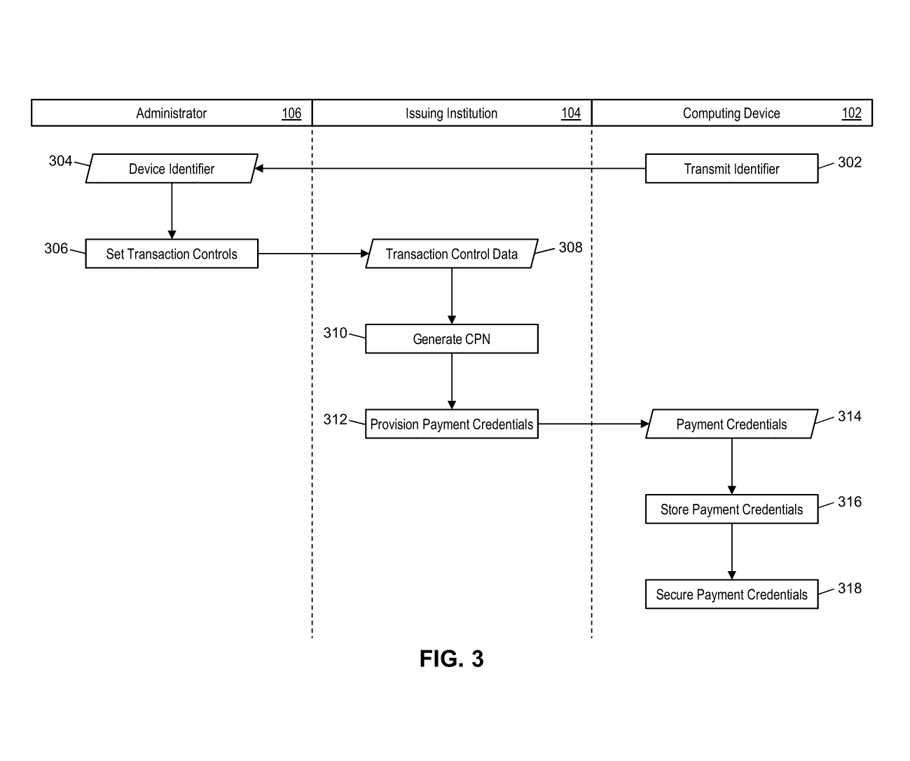

FIG. 3 illustrates a process for the distribution of limited use payment credentials to the computing device 102 in the system 100 illustrated in FIG. 1.

In step 302, the computing device 102 may electronically transmit a device identifier associated therewith to the administrator 106. Transmission of the device identifier may include the display thereof on the display device 220 of the computing device 102, electronic transmission via a data signal superimposed or otherwise encoded with the device identifier electronically transmitted by the transmitting device 216 of the computing device 102, or other suitable method. The device identifier may be a media access control address or other suitable identifying information associated with the computing device 102 or the individual 108 to whom the payment credentials are to be provided. In step 304, the administrator 106 may receive the device identifier.

In step 306, the administrator 106 may set transaction controls for the payment credentials that are to be provisioned to the computing device 102. The administrator 106 may set the transaction controls using any suitable method, such as via an application program or web page executed via a computing device used by the administrator 106. In step 308, the issuing institution 104 may receive the transaction controls as well as the device identifier associated with the computing device 102 to which the payment credentials are to be provisioned. In step 310, the issuing institution 104 may generate a controlled payment number (CPN) for the transaction account, where the controlled payment number is configured to be subject to the transaction controls as provided by the administrator 106. In some embodiments, the CPN may be generated by another entity on behalf of the issuing institution 104, such as the instruction of the issuing institution 104.

In step 312, the issuing institution 104 (e.g., or associated entity) may provision the payment credentials, which includes the generated CPN, to the computing device 104. In step 314, the receiving device 202 of the computing device 102 may receive the payment credentials from the issuing institution 104. The payment credentials may include at least the CPN and any other data used in the funding of a payment transaction, such as an expiration date, security code, payment cryptogram, etc. IN step 316, the querying module 210 of the computing device 102 may execute a query on the memory 218 of the computing device 102 to store the payment credentials therein. In some embodiments, the payment credentials may be stored in a Secure Element, trusted execution environment, or other type of secured storage as part of the memory 218 of the computing device 102. In step 318, the security module 212 of the processing server 102 may secure the payment credentials, where securing of the payment credentials may prevent visual or aural access to the payment credentials by the individual 108, which may include the prevention of redistribution of the payment credentials to another computing device 102. The payment credentials may then be secured from the individual 108, but available for usage in a payment transaction.

Process for Processing of a Payment Transaction with Limited Use Payment Credentials

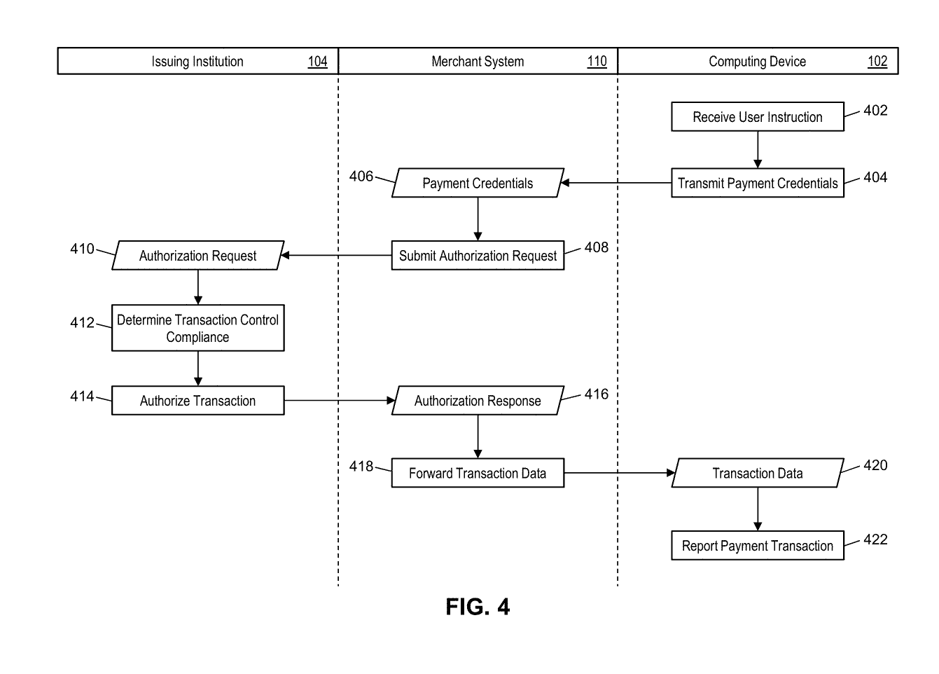

FIG. 4 illustrates a process for the processing of a payment transaction funded via limited use payment credentials provisioned to the computing device 102, such as via the process illustrated in FIG. 3 and discussed above.

In step 402, the input device 222 of the computing device 102 may receive user input from the individual 108 that requests the transmission of secured payment credentials stored therein for funding a payment transaction at a merchant. In step 404, the payment credentials may be transmitted by the computing device 102 using a suitable method. In one example, the transmitting device 216 of the computing device 102 may electronically transmit the payment credentials to the merchant system 110 via near field communication or a local area network. In another example, the display device 220 of the computing device 102 may display a machine-readable code encoded with the payment credentials to be read by the merchant system 110. In some cases, the user instruction may indicate the method for transmitting the payment credentials.

In step 406, the merchant system 110 may receive the payment credentials, which may be received based on the method for transmission used by the computing device 102. In step 408, the merchant system 110 may (e.g., via one or more intermediate entities, as applicable) submit an authorization request to the payment network 112 for a payment transaction that includes the payment credentials and additional transaction data for the payment transaction. The additional transaction data may include, for example, a transaction amount, transaction time, transaction date, geographic location, merchant name, merchant identifier, merchant category code, product data, offer data, reward data, loyalty data, currency type, etc. The authorization request may be a transaction message formatted pursuant to one or more standards, such as the ISO 8583 or 20022 standards, that includes a message type indicator indicative of an authorization request.

In step 410, the issuing institution 104 may receive the authorization request, which may be forwarded to the issuing institution 104 by the payment network 112 using payment rails associated therewith. In step 412, the issuing institution 104 may determine that the payment transaction is in compliance with transaction controls set for the payment credentials. The compliance may be based on data associated with the transaction controls stored in the issuing institution 104, such as associated with the CPN provisioned to the computing device 102 and included in the authorization request, and the transaction data stored in the data elements included in the authorization request. Once the issuing institution 104 determines the payment transaction to comply with the transaction controls, then, in step 414, the issuing institution 104 may authorize the payment transaction by returning an authorization response to the merchant system 110 (e.g., via the payment network 112 and any intermediate entities) that is a transaction message that includes a message type indicator indicative of an authorization request and a data element that is configured to store a response code that indicates approval of the payment transaction. In exemplary embodiments, authorization of the payment transaction may be further based on additional considerations, such as those traditionally used in the authorization of payment transactions, such as account balance of the transaction account, fraud scores, etc.

In step 416, the merchant system 110 may receive the authorization response that indicates approval of the payment transaction. The merchant system 110 may then finalize the payment transaction, such as by furnishing the transacted—for goods or services to the individual 108, and, in step 418, forwarding transaction data to the computing device 102, such as may be included in an electronic receipt that is electronically transmitted to the computing device 102 using a suitable method, such as email, short messaging service message, multimedia messaging service message, notification in an application program, etc. In step 420, the receiving device 202 of the computing device 102 may receive the transaction data, which may include a transaction amount, transaction time, transaction date, merchant name, product data, and any other suitable data related to the payment transaction. In step 422, the transmitting device 216 of the computing device 102 may report the payment transaction to a resource management system or other system associated with the administrator 106 for use thereof, such as in accounting, inventory management, budgeting, etc.

### Exemplary Method for Distributing Limited Use Payment Credentials

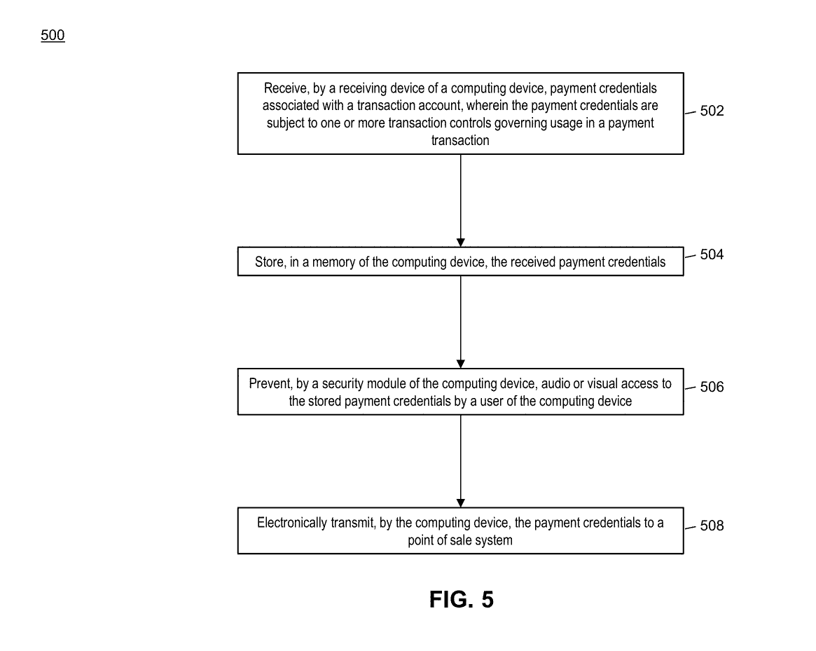

FIG. 5 illustrates a method 500 for the distribution of limited use payment credentials to a computing device that are secured therein from access by a user of the computing device.

In step 502, payment credentials associated with a transaction account may be received by a receiving device (e.g., the receiving device 202) of a computing device (e.g., the computing device 102), wherein the payment credentials are subject to one or more transaction controls governing usage in a payment transaction. In step 504, the received payment credentials may be stored in a memory (e.g., the memory 218) of the computing device.

In step 506, a security module (e.g., the security module 212) of the computing device may prevent audio or visual access to the stored payment credentials by a user (e.g., the individual 108) of the computing device. In step 508, the payment credentials may be electronically transmitted to a point of sale system (e.g., the merchant system 110) by the computing device.

In one embodiment, the method 500 may further include receiving, by an input device (e.g., the input device 222) of the computing device, an instruction from the user of the computing device prior to electronically transmitting the payment credentials. In another embodiment, the payment credentials may be electronically transmitted, by a transmitting device (e.g., the transmitting device 216) of the computing device, using near field communication.

In some embodiments, the payment credentials may be electronically transmitted by being encoded in a machine-readable code displayed by a display device (e.g., the display device 220) of the computing device. In a further embodiment, the machine-readable code may be a quick response code. In one embodiment, the method 500 may further include: receiving, by the receiving device of the computing device, replacement credentials associated with the transaction account; and executing, by a querying module (e.g., the querying module 210) of the computing device, a query on the memory of the computing device to replace the stored payment credentials with the replacement credentials, wherein the computing device does not retain the payment credentials.

In some embodiments, the method 500 may also include receiving, by the receiving device of the computing device, transaction data associated with a payment transaction involving the electronically transmitted payment credentials. In a further embodiment, the method 500 may even further include electronically transmitting, by the transmitting device of the computing device, the received transaction data to an expense management system. In an even further embodiment, the expense management system may be included in the computing device. In another further embodiment, the transaction data may be compliant with the one or more transaction controls.

### Payment Transaction Processing System and Process

FIG. 6 illustrates a transaction processing system and a process 600 for the processing of payment transactions in the system, which may include the processing of thousands, millions, or even billions of transactions during a given period (e.g., hourly, daily, weekly, etc.). The process 600 and steps included therein may be performed by one or more components of the system 100 discussed above, such as the computing device 102, individual 108, issuing institution 104, merchant system 110, payment network 112, etc. The processing of payment transactions using the system and process 600 illustrated in FIG. 6 and discussed below may utilize the payment rails, which may be comprised of the computing devices and infrastructure utilized to perform the steps of the process 600 as specially configured and programmed by the entities discussed below, including the transaction processing server 612, which may be associated with one or more payment networks configured to processing payment transactions. It will be apparent to persons having skill in the relevant art that the process 600 may be incorporated into the processes illustrated in FIGS. 3-5, discussed above, with respect to the step or steps involved in the processing of a payment transaction. In addition, the entities discussed herein for performing the process 600 may include one or more computing devices or systems configured to perform the functions discussed below. For instance, the merchant 606 may be comprised of one or more point of sale devices, a local communication network, a computing server, and other devices configured to perform the functions discussed below.

In step 620, an issuing financial institution 602 may issue a payment card or other suitable payment instrument to a consumer 604. The issuing financial institution may be a financial institution, such as a bank, or other suitable type of entity that administers and manages payment accounts and/or payment instruments for use with payment accounts that can be used to fund payment transactions. The consumer 604 may have a transaction account with the issuing financial institution 602 for which the issued payment card is associated, such that, when used in a payment transaction, the payment transaction is funded by the associated transaction account. In some embodiments, the payment card may be issued to the consumer 604 physically. In other embodiments, the payment card may be a virtual payment card or otherwise provisioned to the consumer 604 in an electronic format.

In step 622, the consumer 604 may present the issued payment card to a merchant 606 for use in funding a payment transaction. The merchant 606 may be a business, another consumer, or any entity that may engage in a payment transaction with the consumer 604. The payment card may be presented by the consumer 604 via providing the physical card to the merchant 606, electronically transmitting (e.g., via near field communication, wireless transmission, or other suitable electronic transmission type and protocol) payment details for the payment card, or initiating transmission of payment details to the merchant 606 via a third party. The merchant 606 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 624, the merchant 606 may enter transaction details into a point of sale computing system. The transaction details may include the payment details provided by the consumer 604 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 606 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 606 may be an online retailer in an e-commerce transaction. In such embodiments, the transaction details may be entered in a shopping cart or other repository for storing transaction data in an electronic transaction as will be apparent to persons having skill in the relevant art.

In step 626, the merchant 606 may electronically transmit a data signal superimposed with transaction data to a gateway processor 608. The gateway processor 608 may be an entity configured to receive transaction details from a merchant 606 for formatting and transmission to an acquiring financial institution 610. In some instances, a gateway processor 608 may be associated with a plurality of merchants 606 and a plurality of acquiring financial institutions 610. In such instances, the gateway processor 608 may receive transaction details for a plurality of different transactions involving various merchants, which may be forwarded on to appropriate acquiring financial institutions 610. By having relationships with multiple acquiring financial institutions 610 and having the requisite infrastructure to communicate with financial institutions using the payment rails, such as using application programming interfaces associated with the gateway processor 608 or financial institutions used for the submission, receipt, and retrieval of data, a gateway processor 608 may act as an intermediary for a merchant 606 to be able to conduct payment transactions via a single communication channel and format with the gateway processor 608, without having to maintain relationships with multiple acquiring financial institutions 610 and payment processors and the hardware associated thereto. Acquiring financial institutions 610 may be financial institutions, such as banks, or other entities that administers and manages payment accounts and/or payment instruments for use with payment accounts. In some instances, acquiring financial institutions 610 may manage transaction accounts for merchants 606. In some cases, a single financial institution may operate as both an issuing financial institution 602 and an acquiring financial institution 610.

The data signal transmitted from the merchant 606 to the gateway processor 608 may be superimposed with the transaction details for the payment transaction, which may be formatted based on one or more standards. In some embodiments, the standards may be set forth by the gateway processor 608, which may use a unique, proprietary format for the transmission of transaction data to/from the gateway processor 608. In other embodiments, a public standard may be used, such as the International Organization for Standardization's ISO 6663 standard. The standard may indicate the types of data that may be included, the formatting of the data, how the data is to be stored and transmitted, and other criteria for the transmission of the transaction data to the gateway processor 608.

In step 628, the gateway processor 608 may parse the transaction data signal to obtain the transaction data superimposed thereon and may format the transaction data as necessary. The formatting of the transaction data may be performed by the gateway processor 608 based on the proprietary standards of the gateway processor 608 or an acquiring financial institution 610 associated with the payment transaction. The proprietary standards may specify the type of data included in the transaction data and the format for storage and transmission of the data. The acquiring financial institution 610 may be identified by the gateway processor 608 using the transaction data, such as by parsing the transaction data (e.g., deconstructing into data elements) to obtain an account identifier included therein associated with the acquiring financial institution 610. In some instances, the gateway processor 608 may then format the transaction data based on the identified acquiring financial institution 610, such as to comply with standards of formatting specified by the acquiring financial institution 610. In some embodiments, the identified acquiring financial institution 610 may be associated with the merchant 606 involved in the payment transaction, and, in some cases, may manage a transaction account associated with the merchant 606.

In step 630, the gateway processor 608 may electronically transmit a data signal superimposed with the formatted transaction data to the identified acquiring financial institution 610. The acquiring financial institution 610 may receive the data signal and parse the signal to obtain the formatted transaction data superimposed thereon. In step 632, the acquiring financial institution may generate an authorization request for the payment transaction based on the formatted transaction data. The authorization request may be a specially formatted transaction message that is formatted pursuant to one or more standards, such as the ISO 6663 standard and standards set forth by a payment processor used to process the payment transaction, such as a payment network. The authorization request may be a transaction message that includes a message type indicator indicative of an authorization request, which may indicate that the merchant 606 involved in the payment transaction is requesting payment or a promise of payment from the issuing financial institution 602 for the transaction. The authorization request may include a plurality of data elements, each data element being configured to store data as set forth in the associated standards, such as for storing an account number, application cryptogram, transaction amount, issuing financial institution 602 information, etc.

In step 634, the acquiring financial institution 610 may electronically transmit the authorization request to a transaction processing server 612 for processing. The transaction processing server 612 may be comprised of one or more computing devices as part of a payment network configured to process payment transactions. In some embodiments, the authorization request may be transmitted by a transaction processor at the acquiring financial institution 610 or other entity associated with the acquiring financial institution. The transaction processor may be one or more computing devices that include a plurality of communication channels for communication with the transaction processing server 612 for the transmission of transaction messages and other data to and from the transaction processing server 612. In some embodiments, the payment network associated with the transaction processing server 612 may own or operate each transaction processor such that the payment network may maintain control over the communication of transaction messages to and from the transaction processing server 612 for network and informational security.

In step 636, the transaction processing server 612 may perform value-added services for the payment transaction. Value-added services may be services specified by the issuing financial institution 602 that may provide additional value to the issuing financial institution 602 or the consumer 604 in the processing of payment transactions. Value-added services may include, for example, fraud scoring, transaction or account controls, account number mapping, offer redemption, loyalty processing, etc. For instance, when the transaction processing server 612 receives the transaction, a fraud score for the transaction may be calculated based on the data included therein and one or more fraud scoring algorithms and/or engines. In some instances, the transaction processing server 612 may first identify the issuing financial institution 602 associated with the transaction, and then identify any services indicated by the issuing financial institution 602 to be performed. The issuing financial institution 602 may be identified, for example, by data included in a specific data element included in the authorization request, such as an issuer identification number. In another example, the issuing financial institution 602 may be identified by the primary account number stored in the authorization request, such as by using a portion of the primary account number (e.g., a bank identification number) for identification.

In step 638, the transaction processing server 612 may electronically transmit the authorization request to the issuing financial institution 602. In some instances, the authorization request may be modified, or additional data included in or transmitted accompanying the authorization request as a result of the performance of value-added services by the transaction processing server 612. In some embodiments, the authorization request may be transmitted to a transaction processor (e.g., owned or operated by the transaction processing server 612) situated at the issuing financial institution 602 or an entity associated thereof, which may forward the authorization request to the issuing financial institution 602.

In step 640, the issuing financial institution 602 may authorize the transaction account for payment of the payment transaction. The authorization may be based on an available credit amount for the transaction account and the transaction amount for the payment transaction, fraud scores provided by the transaction processing server 612, and other considerations that will be apparent to persons having skill in the relevant art. The issuing financial institution 602 may modify the authorization request to include a response code indicating approval (e.g., or denial if the transaction is to be denied) of the payment transaction. The issuing financial institution 602 may also modify a message type indicator for the transaction message to indicate that the transaction message is changed to be an authorization response. In step 642, the issuing financial institution 602 may transmit (e.g., via a transaction processor) the authorization response to the transaction processing server 612.

In step 644, the transaction processing server 612 may forward the authorization response to the acquiring financial institution 610 (e.g., via a transaction processor). In step 646, the acquiring financial institution may generate a response message indicating approval or denial of the payment transaction as indicated in the response code of the authorization response, and may transmit the response message to the gateway processor 608 using the standards and protocols set forth by the gateway processor 608. In step 648, the gateway processor 608 may forward the response message to the merchant 606 using the appropriate standards and protocols. In step 660, assuming the transaction was approved, the merchant 606 may then provide the products purchased by the consumer 604 as part of the payment transaction to the consumer 604.

In some embodiments, once the process 600 has completed, payment from the issuing financial institution 602 to the acquiring financial institution 610 may be performed. In some instances, the payment may be made immediately or within one business day. In other instances, the payment may be made after a period of time, and in response to the submission of a clearing request from the acquiring financial institution 610 to the issuing financial institution 602 via the transaction processing server 612. In such instances, clearing requests for multiple payment transactions may be aggregated into a single clearing request, which may be used by the transaction processing server 612 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 640), the transaction processing server 612 may be configured to perform authorization of transactions on behalf of the issuing financial institution 602. Such actions may be referred to as “stand-in processing,” where the transaction processing server “stands in” as the issuing financial institution 602. In such instances, the transaction processing server 612 may utilize rules set forth by the issuing financial institution 602 to determine approval or denial of the payment transaction, and may modify the transaction message accordingly prior to forwarding to the acquiring financial institution 610 in step 644. The transaction processing server 612 may retain data associated with transactions for which the transaction processing server 612 stands in, and may transmit the retained data to the issuing financial institution 602 once communication is reestablished. The issuing financial institution 602 may then process transaction accounts accordingly to accommodate for the time of lost communication.

In another example, if the transaction processing server 612 is unavailable for submission of the authorization request by the acquiring financial institution 610, then the transaction processor at the acquiring financial institution 610 may be configured to perform the processing of the transaction processing server 612 and the issuing financial institution 602. The transaction processor may include rules and data suitable for use in making a determination of approval or denial of the payment transaction based on the data included therein. For instance, the issuing financial institution 602 and/or transaction processing server 612 may set limits on transaction type, transaction amount, etc. that may be stored in the transaction processor and used to determine approval or denial of a payment transaction based thereon. In such instances, the acquiring financial institution 610 may receive an authorization response for the payment transaction even if the transaction processing server 612 is unavailable, ensuring that transactions are processed and no downtime is experienced even in instances where communication is unavailable. In such cases, the transaction processor may store transaction details for the payment transactions, which may be transmitted to the transaction processing server 612 (e.g., and from there to the associated issuing financial institutions 602) once communication is reestablished.

In some embodiments, transaction processors may be configured to include a plurality of different communication channels, which may utilize multiple communication cards and/or devices, to communicate with the transaction processing server 612 for the sending and receiving of transaction messages. For example, a transaction processor may be comprised of multiple computing devices, each having multiple communication ports that are connected to the transaction processing server 612. In such embodiments, the transaction processor may cycle through the communication channels when transmitting transaction messages to the transaction processing server 612, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 610 may identify that an authorization request involves an issuing financial institution 602 (e.g., via the bank identification number included in the transaction message) for which no value-added services are required. The transaction processor at the acquiring financial institution 610 may then transmit the authorization request directly to the transaction processor at the issuing financial institution 602 (e.g., without the authorization request passing through the transaction processing server 612), where the issuing financial institution 602 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 612 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 608, acquiring financial institution 610, etc.) for processing using this advanced network, and to quickly and efficiently receive a response regarding the ability for a consumer 604 to fund the payment transaction.

### Computer System Architecture

FIG. 7 illustrates a computer system 700 in which embodiments of the present disclosure, or portions thereof, may be implemented as computer-readable code. For example, the computing device 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-6.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for distributing limited use payment credentials. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for distributing limited use payment credentials, comprising:
receiving, by a receiving device of a computing device, payment credentials associated with a transaction account, wherein the payment credentials are subject to one or more transaction controls governing usage in a payment transaction;
storing, in a memory of the computing device, the received payment credentials;
preventing, by a security module of the computing device, audio or visual access to the stored payment credentials by a user of the computing device; and
electronically transmitting, by the computing device, the payment credentials to a point of sale system.

2. The method of claim 1, further comprising:
receiving, by an input device of the computing device, an instruction from the user of the computing device prior to electronically transmitting the payment credentials.

3. The method of claim 1, wherein the payment credentials are electronically transmitted, by a transmitting device of the computing device, using near field communication.

4. The method of claim 1, wherein the payment credentials are electronically transmitted by being encoded in a machine-readable code displayed by a display device of the computing device.

5. The method of claim 4, wherein the machine-readable code is a quick response code.

6. The method of claim 1, further comprising:
receiving, by the receiving device of the computing device, transaction data associated with a payment transaction involving the electronically transmitted payment credentials.

7. The method of claim 6, further comprising:
electronically transmitting, by a transmitting device of the computing device, the received transaction data to an expense management system.

8. The method of claim 7, wherein the expense management system is included in the computing device.

9. The method of claim 6, wherein the transaction data is compliant with the one or more transaction controls.

10. The method of claim 1, further comprising:
receiving, by the receiving device of the computing device, replacement credentials associated with the transaction account; and
executing, by a querying module of the computing device, a query on the memory of the computing device to replace the stored payment credentials with the replacement credentials, wherein
the computing device does not retain the payment credentials.

11. A system for distributing limited use payment credentials, comprising:
a receiving device of a computing device configured to receive payment credentials associated with a transaction account, wherein the payment credentials are subject to one or more transaction controls governing usage in a payment transaction;
a memory of the computing device configured to store the received payment credentials; and
a security module of the computing device configured to prevent audio or visual access to the stored payment credentials by a user of the computing device, wherein
the computing device is configured to electronically transmit the payment credentials to a point of sale system.

12. The system of claim 11, further comprising:
an input device of the computing device configured to receive an instruction from the user of the computing device prior to electronically transmitting the payment credentials.

13. The system of claim 11, wherein the payment credentials are electronically transmitted, by a transmitting device of the computing device, using near field communication.

14. The system of claim 11, wherein the payment credentials are electronically transmitted by being encoded in a machine-readable code displayed by a display device of the computing device.

15. The system of claim 14, wherein the machine-readable code is a quick response code.

16. The system of claim 11, wherein the receiving device of the computing device is further configured to receive transaction data associated with a payment transaction involving the electronically transmitted payment credentials.

17. The system of claim 16, further comprising:
a transmitting device of the computing device configured to electronically transmit the received transaction data to an expense management system.

18. The system of claim 17, wherein the expense management system is included in the computing device.

19. The system of claim 16, wherein the transaction data is compliant with the one or more transaction controls.

20. The system of claim 11, further comprising:
a querying module of the computing device, wherein
the receiving device of the computing device is further configured to receive replacement credentials associated with the transaction account,
the querying module of the computing device is configured to execute a query on the memory of the computing device to replace the stored payment credentials with the replacement credentials, and
the computing device does not retain the payment credentials.
